(19) United States
(12) Patent Application Publication
(10) Pub. No.: US 2019/0306598 A1
(43) Pub. Date: Oct. 3, 2019

(54) METHOD AND APPARATUS FOR CONTROLLING DATA FORWARDING IN PON

(71) Applicant: ALCATEL LUCENT, Nozay (FR)

(72) Inventor: Haibo WEN, Shanghai (CN)

(73) Assignee: Alcatel Lucent, Nozay (FR)

(21) Appl. No.: 16/317,912

(22) PCT Filed: Jul. 17, 2017
(86) PCT No.: PCT/IB2017/001018

§ 371 Date: Jan. 15, 2019

(30) Foreign Application Priority Data
Jul. 28, 2016 (CN) 201610602474.2

(51) Int. Cl. H04Q 11/00; H04B 10/27; H04B 10/25

(52) U.S. Cl. CPC H04Q 11/0067; H04B 10/27; H04Q 2011/0079; H04Q 2011/0073; H04B 10/2503

(57) ABSTRACT

In controlling data forwarding of an optical network unit (ONU) in a passive optical network (PON) system, wherein a management entity is created in the ONU, the management entity supporting management and maintenance for data forwarding rule; the ONU performs forwarding processing for uplink and downlink data according to the data forwarding rule. An OLT performs data forwarding rule management and configuration for the management entity in the ONU through a management protocol, for example in a GPON network environment. The OLT instructs the ONU to configure a corresponding management entity by expanding an optical network unit management control interface (OMCI) protocol message, and generating and maintaining a forwarding rule table. Only the configured or authorized data streams can be permitted to enter the PON network or sent to the user-side device through the ONU, so that the PON network is safe, programmable, more flexible and quick in deploying new services, and meanwhile can better satisfy future application demands of the SDN.

### FIELD

The present disclosure relates to the technical field of communications, and particularly to the technical field of access network systems, and more particularly to a method and apparatus for controlling data forwarding in a PON (Passive Optical Network) system.

### BACKGROUND

A PON system has already been extensively applied to access networks, and further access network should have more programmability. However, a current PON network does not have effective and online real-time forwarding rule configuration mechanism, and an ONU/ONT (Optical Network Unit/Optical Network Terminal) only directly forwards received packets and frames to an OLT (Optical Line Terminal) via an ODN (Optical Distribution Network). This feature might be utilized by a malicious user to launch a DoS (Denial of Service) attack on the OLT.

To make a PON system more efficient, only the permitted and authorized data streams can be forwarded by the ONU/ONT (collectively expressed as ONU hereunder) to the ODN network or user-side terminal, and other data are abandoned by the ONU. In addition, considering support for QoS (Quality of Service), namely, different streams might have different bandwidth requirements, dynamic bandwidth distribution in a GPON (Gigabit-capable Passive Optical Network) is based on a T-CONT (Traffic Container), and different uplink streams in the ONU need to be mapped to different T-CONTs. To sum up, in the PON system, how to effectively perform data forwarding control for ONU is a problem to be solved.

Meanwhile, an SDN (Software Defined Network) is a hot spot in the current industry. Since the network is programmable, many advantages will arise in the future, for example, flexibility, quick deployment of new services and the like. In an SDN-enabled network, only configured or authorized streams can be permitted into SDN domain, and into corresponding data planes for forwarding. Since an edge SDN switch can easily deny or discard packets or data frames that cannot be recognized, it can easily prevent DoS attacks. A method readily envisaged in an SDN environment is the SDN controller's configuration for ONU data forwarding in the SDN network environment shown in FIG. 1, it implements client program of OpenFlow on the ONU, and this manner requires allocation of an IP address to the ONU to establish a safe channel between the ONU and the SDN controller, and then the configuration of data forwarding control is implemented through this safe channel. However, this method has the following drawbacks:

1. There must be OpenFlow client implemented on the ONU, yet the client is implemented on a TCP/IP (Transfer Control Protocol/Internet Protocol) layer. Furthermore, one IP address needs to be allocated to the ONU to establish a safe channel with the SDN controller.

2. There must be an additional SDN controller to configure the ONU data forwarding. In fact, only some simple rules may need to be configured on the ONU, for example, a source MAC (Media Access Control) address, a source IP address matching pair, that is, only Ethernet frames satisfying the designated source MAC address and source IP address can be forwarded by the ONU to the OLT.

3. In this control manner, the PON system needs to be allocated a channel with higher reliability and certain bandwidth to establish the channel between the SDN controller and the ONU, and such channel needs to be allocated between each ONU and OLT.

4. In such solution, the ONU channel is simultaneously controlled by the OLT and the SDN controller, which might cause potential conflicts in control or configuration.

### SUMMARY

The present disclosure provides an effective mechanism to implement data forwarding control configuration in a PON system, and provides implementing data forwarding control configuration for the ONU through a PON network management protocol.

According to an aspect of the present disclosure, there is provided a method of controlling data forwarding of an optical network unit ONU in a passive optical network PON system, comprising: creating a management entity in the ONU, the management entity supporting management and maintenance for data forwarding rule; performing, by the ONU, forwarding processing for uplink and downlink data according to the data forwarding rule.

Preferably, an optical line terminal (OLT) creates the management entity in the ONU through a management protocol, to support the management and maintenance for the data forwarding rule.

Preferably, the PON network is a Gigabit-capable passive optical network (GPON), and the OLT instructs the ONU to configure the corresponding data forwarding rule by expanding an optical network unit management control interface (OMCI) protocol message.

Preferably, the expanded OMCI protocol message includes: a message identifier domain including a management entity identifier and a management instance identifier, the management entity identifier identifying the data forwarding rule management entity in the ONU, the management instance identifier identifying a specific management instance in the management entity.

Preferably, the expanded OMCI protocol message includes: a message type domain for operating the data forwarding rule management entity and its management instance in the ONU, the operating including: creating, deleting, setting and getting data forwarding rule management entity or management instance.

Preferably, the expanded OMCI protocol message includes: a message content domain including a plurality of matching items for identifying several rule domains and/or action domains, lengths and values involved in the data forwarding by the data forwarding rule entity and its management instance of the ONU. The plurality of rule domains involved in the data forwarding include an input port, a source media access control (MAC) address, a source IP address, a destination IP address, a virtual local network (VLAN) identifier. The plurality of action domains involved in the data forwarding include an output port and a VLAN tag processing.

According to another aspect of the present disclosure, there is provided an optical line terminal of controlling data forwarding of an optical network unit (ONU), comprising: a management unit configured to manage and configure an ONU management entity in a passive optical network (PON) system to support the ONU's management and maintenance for the data forwarding rule; a protocol unit configured to manage and configure the management entity in the ONU with a management protocol.

Preferably, the protocol unit is configured to instruct the ONU to configure a corresponding forwarding rule table by expanding an optical network unit management control interface (OMCI) protocol message.

Preferably, the protocol unit is configured to set a management entity identifier and a management instance identifier in the message identifier domain, the management entity identifier identifying a data forwarding rule management entity in the ONU, the management instance identifier identifying a specific management instance in the management entity.

Preferably, the protocol unit is configured to set, by expanding the OMCI protocol message, a message type in a message type domain for operating the data forwarding rule management entity and its management instance in the ONU, the operating including creating, deleting, setting and getting the data forwarding rule management entity or management instance.

Preferably, the protocol unit is configured to include, by expanding the OMCI protocol message, a plurality of matching items in a message content domain for identifying a plurality of rule domains and/or action domains, lengths and values involved in the data forwarding by the data forwarding rule entity and its management instance of the ONU.

Preferably, the protocol unit further receives an instruction from a Software Defined Network (SDN) controller to perform management and configuration for the ONU management entity in the PON system.

According to a further aspect of the present disclosure, there is provided an optical network unit (ONU) supporting data forwarding control, comprising: a protocol unit configured to receive, from the optical line terminal OLT through the management protocol, configuration for the management entity unit in the ONU; a management entity unit configured to manage and maintain a local data forwarding rule table based on the configuration of the OLT; and a data processing unit configured to perform forwarding processing for uplink and downlink data according to the data forwarding rule table.

Preferably, the protocol unit further reports to the OLT attributes of the management entity and management instance in the ONU.

According to the method and apparatus provided by embodiments of the present disclosure, a management entity for data forwarding rule is set for the ONU through the PON network management protocol so that only the configured or authorized data streams in the uplink and downlink network data in the ONU can be permitted to enter through the ONU on the user side into the PON network or be sent to the user-side device through the ONU, which makes the PON network safe, programmable, more flexible and quick in deploying new services, and meanwhile can better satisfy future application demands of the SDN network.

### BRIEF DESCRIPTION OF THE DRAWINGS

Through the following detailed description with reference to the accompanying drawings, the features, characteristics and advantages of the present disclosure will become more apparent. The same elements are denoted by the same reference numbers in the figures, wherein:

FIG. 1 illustrates an SDN controller configuring for the ONU/ONT data forwarding under an SDN environment;

FIG. 2 illustrates an embodiment of performing forwarding rule configuration for an optical network unit in a GPON according to the present disclosure;

FIG. 3 illustrates an embodiment of OMCI protocol expansion enabling forwarding rule configuration for an optical network unit according to the present disclosure;

FIG. 4A illustrates an embodiment of OMCI protocol-message type domain expansion according to the present disclosure;

FIG. 4B illustrates an embodiment of OMCI protocol-message identifier domain expansion according to the present disclosure;

FIG. 4C illustrates an embodiment of OMCI protocol-message content domain expansion according to the present disclosure;

FIG. 5 illustrates a structural diagram of a data forwarding table in an optical network unit based on OMCI protocol expansion according to the present disclosure;

FIG. 6 illustrates an exemplary block diagram of OLT enabling forwarding rule configuration for an optical network unit according to the present disclosure;

FIG. 7 illustrates an exemplary block diagram of ONU enabling forwarding rule configuration for an optical network unit according to the present disclosure.

### DETAILED DESCRIPTION OF EMBODIMENTS

In the detailed depictions of the preferable embodiments, reference will be made to the accompanying drawings that constitute part of the present disclosure. The appended figures show specific embodiments that can implement the present disclosure in an exemplary manner. The exemplary embodiments are not intended to exhaust all the embodiments according to the present disclosure. It should be noted that, although steps of the method in the present disclosure are described in a particular order in the text, it does not require or imply that these operations must be performed according to this particular order, or a desired outcome can only be achieved by performing all shown operations. On the contrary, the execution order for the steps as depicted in the flowcharts may be varied. Additionally or alternatively, some steps may be omitted, a plurality of steps may be merged into one step, and/or a step may be divided into a plurality of steps for execution.

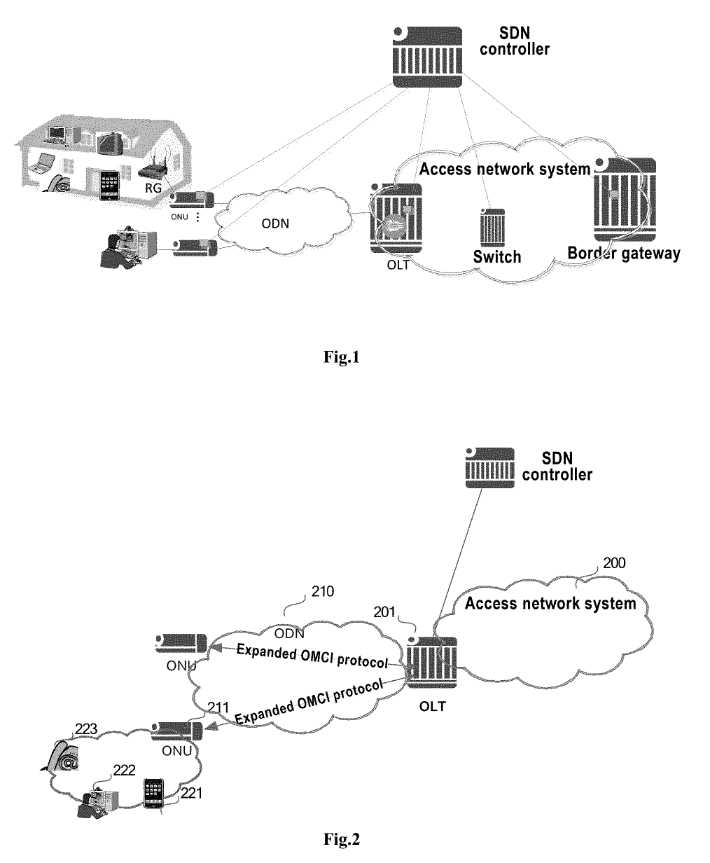

FIG. 2 illustrates an embodiment of performing forwarding rule configuration for an optical network unit in a GPON network according to the present disclosure. The network includes an optical line network terminal (OLT) 201 located at an edge of an access network system 200, and several optical network units (ONUs) 211 connected with the OLT 201 through an ODN 210. A management entity (ME) is created in the ONU, enabling the management and maintenance of ONU data forwarding rule, and the ONU performs forwarding processing for uplink and downlink data according to the data forwarding rule. ONU 211 is taken as an example. A user network 220 connected with the ONU 211 includes three user terminals, namely, a mobile phone 221, a desktop computer 222 and a notebook computer 223.

Through the management and maintenance of the data forwarding rule in the ONU, for example, the management entity ME maintains a data forwarding rule table in the ONU, and the table is comprised of a series of forwarding table items; each forwarding table item is a forwarding rule set by the OLT, and each table item may be in the following format: <forwarding rule instance, rule domain, action domain>.

Regarding any received data frame, the ONU may compare features of the data frame, for example, input port and feature domains such as a source MAC address, a source IP address and a destination IP address in the data frame, with rule domains in the data forwarding rule table. When one or more features of the data frame are found satisfying the rule domains in the data forwarding rule table, the data frame will be processed in a designated manner in the action domain, for example, to be placed in a certain output port queue for forwarding, or directly forwarded, or added a designated VLAN tag, or the like; if no match rule is found, the data frame will be discarded.

The data forwarding rule indicates rules that must be observed for data from the user network 220 or access network system 200, only when the received data frame matches the rule domain designated by a certain forwarding rule management instance can it be judged that the data frame is the data authorized by the forwarding rule, and can the data frame be processed in a designated action manner, for example, be placed in a certain specific T-CONT queue for processing.

According to an embodiment provided by the present disclosure, creation of the management entity (ME) in the ONU may be obtained by acquiring software mirror update from the OLT. After the software update is activated, the ONU generates a corresponding management unit to perform the management and maintenance for the data forwarding rule.

According to an embodiment provided by the present disclosure, the OLT performs the management and configuration of the data forwarding rule for the management entity in the ONU through an expansion management protocol. In the following detailed depictions, depictions are presented here by taking OMCI protocol expansion of the GPON system as an example. However, those skilled in the art may understand that the principles of the present disclosure can be easily implanted to EPON (Ethernet Passive Optical Network) system, implemented by expanding an OAM (Operation Administration and Maintenance) protocol.

As well known by those skilled in the art, various OMCI management entities (MEs) are defined in ITU-T G. 988 protocol of Telecommunication Standardization Department of International Telecommunication Union, and these MEs include compulsory MEs for a system conforming to the corresponding protocol and MEs needed according to a function set to be provided by the ONU. However, as stated above, current protocols do not define any management entity for managing the data forwarding rule in the ONU.

The OMCI protocol runs upon a GEM (GPON Encapsulation Mode) connection between the OLT controller and the ONU controller, the GEM connection is established upon initialization of the ONU. By establishing a dedicated ATM PVC (Permanent Virtual Circuit) or a GEM port transmission OMCI protocol message between the OLT and ONT, the ONU establishes an OMCI channel upon registration to the OLT. The OMCI is a master-slave type management protocol, wherein the OLT is a master device and ONU is a slave device, and the OLT controls a plurality of ONU devices of the OLT through the OMCI channel. Baseline type OMCI message is fixed as having 53 bytes, and Extend type OMCI message has a maximum of 1980 bytes. The OMCI in the GPON is used for the following four purposes: configuration management, fault management, performance management and security management. However, in the configuration management, how to complete the setting of the ONU data forwarding rule is not defined currently. Hereunder how to expand the OMCI protocol will be illustrated to implement the forwarding rule configuration on the ONU.

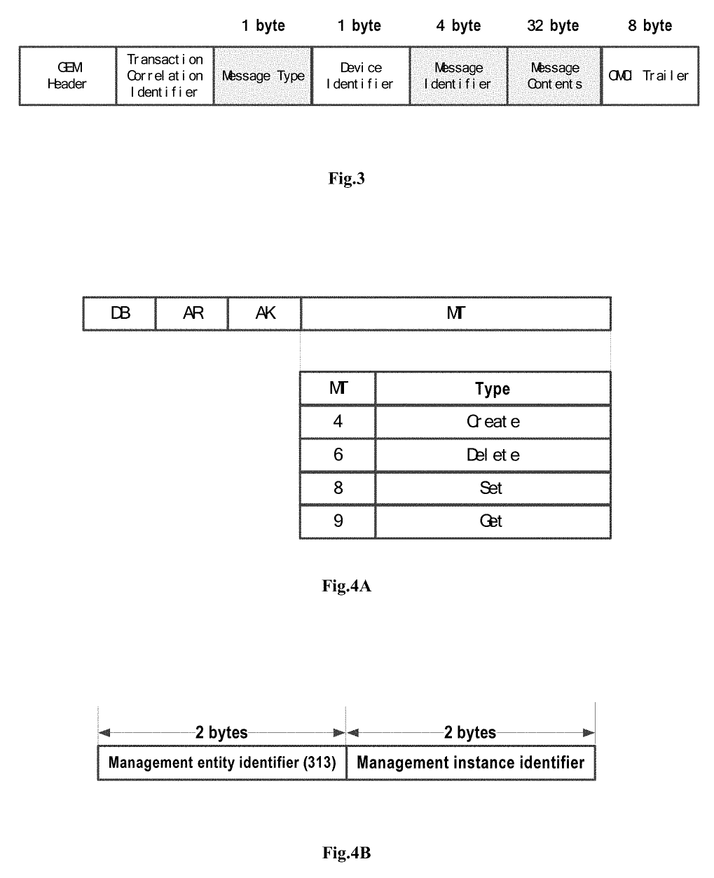

FIG. 3 illustrates an embodiment of OMCI protocol expansion enabling forwarding rule configuration for an optical network unit according to the present disclosure. The OMCI protocol is transmitted in the packet format shown in the figure. One OMCI protocol in the figure includes fields such as ATM/GEM header, Transaction Correlation Identifier, Device Identifier, Message Identifier, Message Contents, Message Type, and OMCI trailer, wherein:

The GEM header domain includes information for distinguishing different GEM ports.

A value of the Transaction Correlation Identifier domain should be consistent in a set of messages corresponding to request and response. In the Baseline type OMCI message, the highest bit of this field indicates a priority level of the OMCI message.

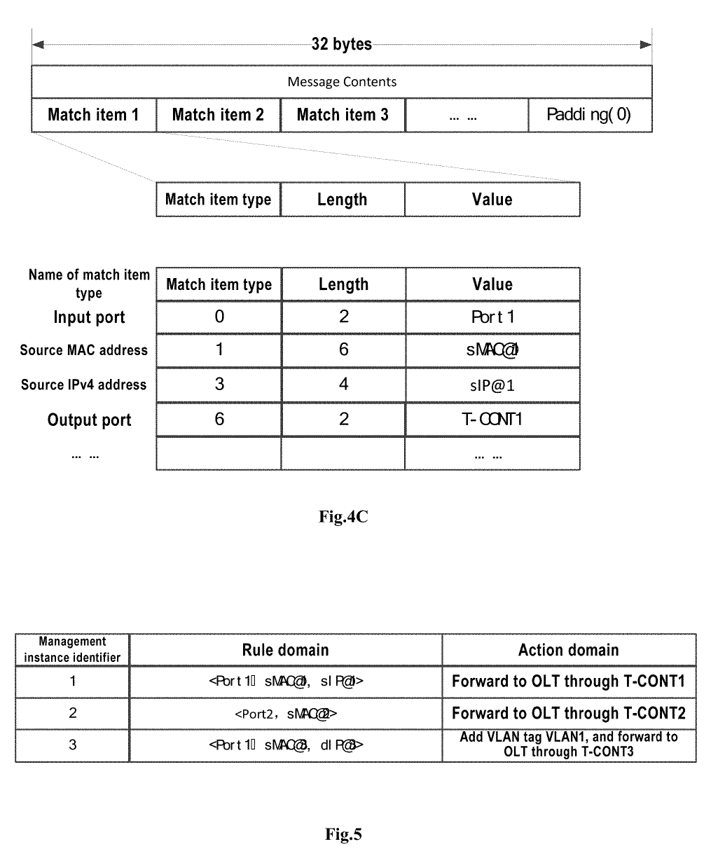

The Message Type domain comprises DB, AR, AK identifier bits and MT message type, wherein DB serves as a destination bit and is usually 0 in OMCI; AR is an answer request bit, wherein when information needs to be acknowledged, AR is 1, and when information doesn't need to be acknowledged, AR is 0; AK indicates whether the Message is acknowledgement information, if the message is the acknowledgement information, AK is 1; if not, AK is 0; MT indicates a message type, corresponding type values 0-3 and 29-31 are used for reservation, the protocol already defines type values 4-28, wherein four message types may be used for the management entity for the ONU data forwarding rule. Illustration is presented in conjunction with an embodiment of OMCI protocol-message type domain expansion provided in FIG. 4A. The four message types are: Create message type (corresponding to type value 4), Delete message type (corresponding to type value 6), Set message type (corresponding to type value 8), and Get message type (corresponding to the type value 9). The following Table 1 specifically shows the purpose of each message type, and the setting of other relevant identifier bit: Create message type is used to create on the ONU management forwarding rule management entity and its management instance; Delete message type is used to delete a management instance; Set message type is used to set one or more rule domains and/or action domains of a management entity; Get message type is used to query and get attributes of a designated management instance.

TABLE 1

| | | | | Inc MIB |
|---|---|---|---|---|
| MT | Type | Purpose | AK | Data Sync |
| 4 | Create | Create a management entity and | Yes | Yes |
| | | its management instance | | |
| 6 | Delete | Delete a management instance | Yes | Yes |
| 8 | Set | Set a management instance | Yes | Yes |
| 9 | Get | Get attributes of a management | Yes | No |
| | | instance | | |

The Message Identifier domain is comprised of four bits, the first two bits are management entity identifiers and used to indicate a target entity to which the message is directed, i.e., indicate a specific management entity (ME), and abstractly represent resources and services of the ONU. The last two bits are used to indicate a certain specific management instance in the management entity (ME). Table 11-2 in ITU-T G. 984.4 Gigabit-capable passive optical network (GPON) specification, namely, management entity ME type table lists ME types currently enabled by the ONU, each item includes a Class Value of a ME. The range of class values 1-312 have been definitely defined currently. The class values 313-65279 are reserved for future standardization. In conjunction with the embodiment of OMCI protocol-message identifier domain expansion provided by FIG. 4B, an application may be filed for a class value for a defined new management entity ME, for example, 313 is used to define the enabling of the ONU for the data forwarding rule. A management instance of a forwarding rule management entity is a specific forwarding rule. The last two bytes of the message identifier domain is an index value of the forwarding rule.

Regarding the Device Identifier domain, OxA represents Baseline type, and OxB represents Extend type.

The Message Contents domain includes 32 bytes and may include a plurality of match items. When the match items are not sufficient to fill the domain, 0 is used to fill. In conjunction with the embodiment of OMCI protocol-message content domain expansion provided by FIG. 4C, each match item is in a Type Length Value format, namely, three domains: match item type, length and value, wherein the match item type indicates rules domains and/or action domains in the involved management instance. Typical rule domains are, for example, an input port, a source MAC address (sMAC), a source IP address (sIP), a destination IP address (dIP), a virtual local area network (VLAN) and the like; typical action domains are, for example, an output port (T-CONT), and addition VLAN and the like; the length indicates a length of bytes required by the rule type value, for example, one input port uses a length of two bytes, the source MAC address uses a length of 6 bytes, a source IP address uses a length of 4 bytes, and an output port uses a length of two bytes; the domain of value indicates a match value of the rule type, for example, the input port uses Port 1 to represent user port 1, the source MAC address uses “sMAC@1” to represent the MAC address of a user equipment, the source IP address uses “sIP@1” to represent the IP address of a user equipment, and the output port uses “T-CONT1” to represent a carrier of the ONU for carrying transactions in uplink direction of the GPON. The match item shown in FIG. 4C has already been respectively defined as representing rule domain/action domain type, length and value in a management entity, wherein the match item type 0 represents the input port, the match item type 1 represents the source MAC address, the match item type 3 represents a source IPv4 address, and the match item type 6 represents an output port . . . . Some other match items may be defined if needed. Since the length of the domain in the packet format of the ONU management control protocol is 32 bytes, it may include one or more match items so long as the total length of the multiple match items does not exceed 32 bytes. If all the match items of the rule domain and/or action domain in a management instance cannot fill up the domain, the remaining space will be filled with 0. If a Message Contents domain cannot accommodate the rule domain and/or action domain in a management instance, an additional configuration message is needed to transfer the remaining match items. For example, Create message type is used to transfer partial match items of a rule, and Set message type is used to transfer the remaining match items.

OMCI trailer: as for Baseline type OMCI message, two bytes are message length 0x28, and four bytes CRC32; as for the Extend type OMCI message, there are only four bytes CRC32.

FIG. 5 illustrates a structural diagram of a data forwarding table in an optical network unit based on OMCI protocol expansion according to the present disclosure. The OLT creates a management entity and instance for data forwarding rule in the ONU based on the OMCI protocol expansion. It is feasible, according to the management instance identifier in the message identifier domain, the MT message type in the message type domain and several match items in the Message Contents domain in the expanded OMCI protocol, to create, delete, set and get rule domain and/or action domain in the corresponding management instance identifier in the data forwarding rule table. In conjunction with FIG. 4C, if a forwarding rule is <input port=1, source MAC address=MAC@1, source IPv4 address=IP@1, output port=T-CONT1>, the Message Contents domain corresponding to the Create or Get message type will use four match items to respectively represent the aforesaid rule domain or action domain, they fill 22 bytes in the Message Contents domain, and the remaining 10 bytes are filled with 0.

According to the established data forwarding rule table, the ONU performs forwarding processing for the received uplink and downlink data. When the data flows from the user side to the network side, for example, when the data forwarding rule corresponding to the management instance identifier is 1 in the table, it means the ONU receives data from a designated input port “Port1”. If its source MAC address and source IPv4 address are respectively designated source MAC address sMAC@1, and sIP@, the data packet will be forwarded to the OLT through T-CONT; regarding the data received by the ONU from the designated input port “2”, if its source MAC address is the designated source MAC address sMAC@2, the data packet will be forwarded to the OLT through T-CONT2; regarding the data received by the ONU from the designated input port “Port 1”, if its source MAC address and destination IPv4 address are respectively designated source MAC address sMAC@3 and dIP@3, the data frame will be added with VLAN tag VLAN1 and forwarded to the OLT through T-CONT3; when the data flows from the network side to the user side, an ingress port refers to a certain specific GEM port, and an egress port refers to the user port or a logical port on the user port. This is not detailed any more here.

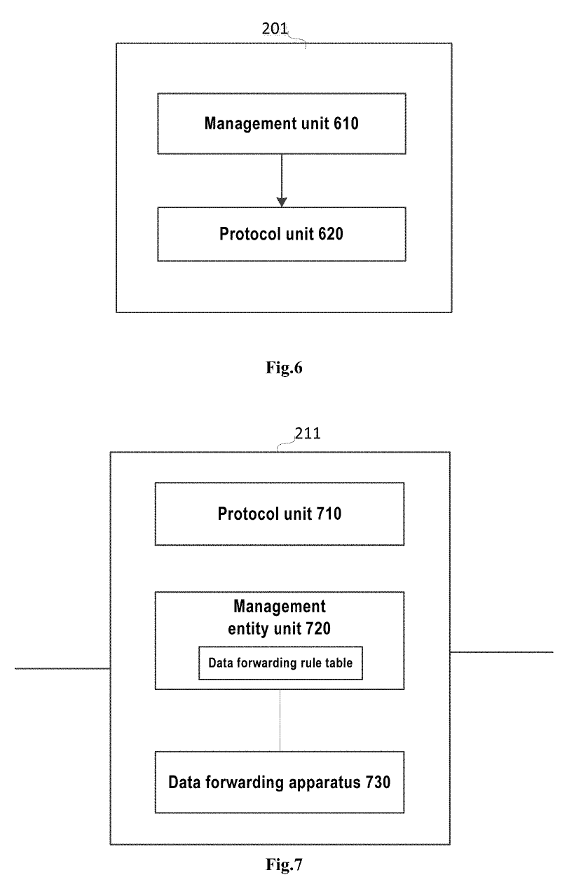

FIG. 6 illustrates an exemplary block diagram of OLT enabling forwarding rule configuration for an optical network unit according to the present disclosure, an OLT 201 includes a management unit 610, and a protocol unit 620, wherein:

The management unit 610 is configured to manage and configure a management entity in the ONU connected to the OLT, enabling the management entity to support the ONU's management and maintenance for the data forwarding rule.

The protocol unit 620 performs the management and configuration for the management entity in the ONU through the management protocol. The protocol unit 620 may obtain an ONU software mirror and send it to the ONU. The ONU software mirror includes enabling the ONU to generate a corresponding management entity to perform management and maintenance for the data forwarding rule. In addition, in conjunction with the OMCI protocol expansion manner in the aforesaid GPON environment, the protocol unit 620 also expands an optical network unit management control interface (OMCI) protocol message to instruct the ONU to configure a corresponding management entity to support the ONU's management and maintenance for the data forwarding rule. It may set a management entity identifier and a management instance identifier in the message identifier domain of the OMCI protocol message sent to the ONU, wherein the management entity identifier is a new management entity (ME) and applies for a class value such as 313 to define the ONU's support for the data forwarding rule; the management instance identifier is used to indicate a specific management instance in the management entity identifier, namely, a data forwarding rule. Meanwhile, the protocol unit 620 sets, in the message identifier domain of the OMCI protocol message sent to the ONU, message type (MT) for operating the data forwarding rule management entity and its management instance in the ONU, and these message types include: Create, Delete, Set and Get data forwarding rule management entity or management instance. The protocol unit 620 may include several match items in the message identifier domain of the OMCI protocol message sent to the ONU, to perform management for several rule domains and/or action domains involved by the data forwarding in the ONU data forwarding rule entity and its management instance, and contents in these domains. Typical rule domains are, for example, an input port, a source MAC address, a source IP address, a destination IP address, a VLAN and the like; typical action domains are, for example, an output port, and addition VLAN and the like.

According to an embodiment provided by the present disclosure, the protocol unit 620 in the optical line terminal may further receive an instruction from an SDN controller to perform management and configuration for the management entity in the ONU. Such PON network is programmable, more flexible and fast in deploying new services. Only configured or authorized streams can be permitted to enter through the ONU on the user side into the SDN domain data plane for forwarding.

FIG. 7 illustrates an exemplary block diagram of ONU enabling forwarding rule configuration for an optical network unit according to the present disclosure. An ONU 211 may comprise a protocol unit 710, a management entity unit 720, and a data processing unit 730, wherein:

The protocol unit 710 receives the configuration for the management entity and management instance from the OLT through the management protocol, it may obtain and ONU software mirror from the OLT through the management protocol, and the ONU software mirror includes enabling the ONU to generate a corresponding management entity; in addition, in conjunction with the OMCI protocol expansion manner under the aforesaid GPON environment, the protocol unit 710 also receives a control instruction from the OLT by expanding an optical network unit management control interface (OMCI) protocol message, establishing and maintaining a local management entity unit to support the ONU's management and maintenance for the data forwarding rule, for example, the management entity identifier in the message identifier domain in the OMCI message is a new class value 313, which indicates that the message is used for a new management entity and defines the ONU's support for the data forwarding rule.

The management entity unit 720. The management entity supports the ONU's management and maintenance for the data forwarding rule, and generates and stores a data forwarding rule table. A management entity identifier and a management instance identifier are set in the message identifier domain of the received OMCI protocol message, and message type (MT) is set in the message type domain for operating the data forwarding management entity and its management instance in the ONU, and these message types include: Create, Delete, Set and Get data forwarding rule forwarding rule management entity or management instance; the Message Contents domain includes several match items, and these match items are used to perform management for several rule domains and/or action domains and their contents involved in the data forwarding of data forwarding rule entity and its management instance by the ONU, for example, an input port, a source MAC address, a source IP address, a destination IP address, an output port, a VLAN and the like. The management entity unit 710 may create and maintain a data forwarding rule table in the ONU. A typical forwarding rule shown in FIG. 5 may include management instance identifier, rule domain, and action domain.

The data processing unit 730 performs forwarding processing for uplink and downlink data according to the data forwarding rule. When the data flows from the user side to the network side, for example, refer to the data forwarding rule corresponding to the management instance identifier as 1 in FIG. 5, the data processing unit 730 is configured in a way that regarding data received from a designated input port “1”, if its source MAC address and source IPv4 address are respectively designated source MAC address sMAC@1, and sIP@, the data satisfies the rule domain in the instance identifier, and the data packet will be processed in a manner designated in the action domain, namely, the data packet will be forwarded to the OLT through T-CONT. When the data flows from the network side to the user side, an ingress port refers to a certain specific GEM port, and an egress port refers to the user port or a logical port on the user port. This is not detailed any more here.

According to an embodiment provided by the present disclosure, the protocol unit 710 may further report to the OLT attributes of the management entity and management instance through the OMCI management protocol.

Through the depictions of the above embodiments, those skilled in the art can clearly understand that the present disclosure may be implemented by software with additional necessary hardware platforms, or certainly may be implemented completely by hardware.

The former is an optimal implementation mode in most cases. Based on such understanding, all or part of the technical solutions of the present disclosure making contribution over the background art may be embodied in the form of a software product. The computer software product may be stored in a storage medium, e.g., ROM/RAM, magnetic disk, compact disk or the like, and includes several instructions to enable a computer device (a personal computer, a server, a network device or the like) to execute the method as stated in all embodiments or some portions of the embodiments of the present disclosure.

The above embodiments are only used to illustrate the technical solutions of the present disclosure, not to limit the present disclosure; although the present disclosure is described in detail with reference to the above preferred embodiments, those having ordinary skill in the art should understand that they can still make amendments or equivalent substitutions for the technical solutions of the present disclosure, and these amendments or equivalent substitutions cannot make the amended technical solutions depart from the spirit and scope of technical solutions of the present disclosure.

1. A method of controlling data forwarding of an optical network unit (ONU) in a passive optical network (PON) system, comprising:
creating a management entity in the ONU, the management entity supporting management and maintenance for data forwarding rule; and
performing, by the ONU, forwarding processing for uplink and downlink data according to the data forwarding rule.

2. The method according to claim 1, wherein the management entity is created by an optical line terminal (OLT) in the ONU with a management protocol to support the management and maintenance for the data forwarding rule.

3. The method according to claim 1, wherein the PON network is a Gigabit-capable passive optical network (GPON), and the OLT instructs the ONU to configure the corresponding data forwarding rule by expanding an optical network unit management control interface (OMCI) protocol message.

4. The method according to claim 3, wherein the expanded OMCI protocol message includes:
a message identifier domain including a management entity identifier and a management instance identifier, the management entity identifier identifying a data forwarding rule management entity in the ONU, and the management instance identifier identifying a specific management instance in the management entity.

5. The method according to claim 3, wherein the expanded OMCI protocol message includes:
a message type domain for operating the data forwarding rule management entity and its management instance in the ONU, the operating including creating, deleting, setting, and getting the data forwarding rule management entity or management instance.

6. The method according to claim 5, wherein the expanded OMCI protocol message includes:
a message content domain including a plurality of match items for identifying a plurality of rule domains and/or action domains, lengths, and values involved in the data forwarding by the data forwarding rule management entity and its management instance of the ONU.

7. The method according to claim 6, wherein the plurality of rule domains involved in the data forwarding include an input port, a source media access control (MAC) address, a source IP address, a destination IP address, and a virtual local network (VLAN) identifier, and wherein the plurality of action domains involved in the data forwarding include an output port and a VLAN tag processing.

8. An optical line terminal for controlling data forwarding of an optical network unit (ONU), comprising:
a management unit configured to manage and configure an ONU management entity in an passive optical network (PON) system to support management and maintenance for data forwarding rule by the ONU; and
a protocol unit configured to manage and configure the management entity in the ONU with a management protocol.

9. The optical line terminal according to claim 8, wherein the protocol unit is configured to instruct the ONU to configure a corresponding forwarding rule table by expanding an optical network unit management control interface (OMCI) protocol message.

10. The optical line terminal according to claim 8, wherein the protocol unit is configured to set a management entity identifier and a management instance identifier in a message identifier domain by expanding an OMCI protocol message, the management entity identifier identifying a data forwarding rule management entity in the ONU, and the management instance identifier identifying a specific management instance in the management entity.

11. The optical line terminal according to claim 8, wherein the protocol unit is configured to set, by expanding an OMCI protocol message, a message type in a message type domain for operating the data forwarding rule management entity and its management instance in the ONU, the operating including creating, deleting, setting, and getting the data forwarding rule management entity or management instance.

12. The optical line terminal according to claim 8, wherein the protocol unit is configured to include, by expanding an OMCI protocol message, a plurality of match items in a message content domain for identifying a plurality of rule domains and/or action domains, lengths, and values involved in the data forwarding by the data forwarding rule entity and its management instance of the ONU.

13. The optical line terminal according to claim 8, wherein the protocol unit further receives an instruction from a software defined network (SDN) controller to perform the management and configuration for the ONU management entity in the PON system.

14. An optical network unit for supporting data forwarding control, comprising:
a protocol unit configured to receive, from an optical line terminal (OLT) through a management protocol, configuration of a management entity unit in an ONU;
a management entity unit configured to manage and maintain a local data forwarding rule table based on the configuration of the OLT; and
a digital processing unit configured to perform forwarding processing for uplink and downlink data according to the data forwarding rule table.

15. The optical network unit according to claim 14, wherein the protocol unit further reports to the OLT attributes of the management entity and a management instance in the ONU.
